(19) United States
(12) Patent Application Publication
(10) Pub. No.: US 2012/0265410 A1
(43) Pub. Date: Oct. 18, 2012

(54) METHOD AND APPARATUS FOR CONTROLLING SEED POPULATION

(76) Inventors: TOBY E. GRAHAM, STERLING, CO (US); JERRY D. GRAHAM, WRAY, CO (US)

(21) Appl. No.: 13/072,561

(22) Filed: Mar. 25, 2011

(51) Int. Cl. G06F 7/00

(52) U.S. Cl. 701/50

(57) ABSTRACT

Provided is an apparatus and method for controlling seed population for a conventional row crop planter utilizing a microprocessor, information from a seed population controller provided with the conventional row crop planter, a GPS or other locating or positioning device and motors for driving the conventional seed metering system of the planter. The microprocessor further feedback from the motors and compares the actual seed population data with the desired density and adjusts the output of the motors to compensate for variations in seed population densities.

### FIELD OF THE INVENTION

1. Background of the Invention

The present disclosed technology relates generally to agricultural seeding machines, and in particular an apparatus and method for controlling the seed population during the planting process.

2. Description of the Related Art

In the agricultural industry, a class of crops designated as row crops, meaning those crops planted in furrows, are planted utilizing a seed planter. The seed planter may utilize a number of seed planning row units attached to a tool bar of the planter. The individual seed row units are evenly spaced along the tool bar so that seeds are planted in rows at a specified distance apart.

Each seed row unit has a hopper in which the seeds are placed. A metering disk regulates the seeds dropping from the hopper into a seed tube that guides the seed into the ground. Various systems may be employed to facilitate the dropping of the seed into the seed tube. Some systems utilize gravity to direct the seeds whereas others may utilize a vacuum system.

The metering disk utilizes holes or cavities that accept the seed, typically one seed per hole or cavity, from the seed hopper. As the metering disk rotates, the individual seed drops into the seed tube. A sprocket and chain drive may be employed to rotate the seed disk, or the hydraulics system of the tractor may also be used. The metering disk provides for a range of settings for controlling the spacing of seeds, and the rate in which the seeds are placed in the seed tube. The ability to control seed population is vital for farming operations. If the seeds are planted too close together, the quality of crops may be affected. Conversely, if the seeds are planted too far apart, the number of bushels per acre is reduced. The rate at which the seeds are planted affect the seed population over a given area and is commonly call a seed population density.

The rate the seeds are planted can be affected by wear and/or limitations of the planter. In mechanical chain driven systems, as the associated drivetrain becomes worn, there is a tendency for the lag in the system that results in uneven seed spacing or a change of the seed population per row. This may also occur when the hydraulics system experiences a leak or a drop in pressure. Likewise, the terrain may also affect the seed population density. GPS systems are often used to determine the location of the tractor and may be utilized to program the seed population for a given area of the field.

Therefore, there is a need for a system and method to accurately control seed population for both hydraulically and mechanically-driven seed row units that provides accurate seed placement and provides for alternative seed population densities over a specific area of the field.

### SUMMARY OF THE INVENTION

The present invention provides an apparatus and method for controlling seed population for a conventional row crop planter that does not suffer from the problems and limitation of prior art seed metering systems as set forth above.

One embodiment of the present invention utilizes a power unit to control the rate of rotation of the metering disk. A sensor monitors the rotational speed of the metering disk and provides an input into a controller. The controller also receives a signal from the original seed planter population control unit, which provides an output based upon the translation seed of the planter. The controller compares the output of the original seed population control unit with the output provided by the sensor monitoring the speed of the metering disk. The controller processes a feedback loop and provides an output in the form of electrical current to power the power unit that rotates the metering disk.

### BRIEF DESCRIPTION OF THE DRAWINGS

The drawings constitute a part of this specification and include exemplary embodiments of the disclosed subject matter illustrating various objects and features thereof, wherein like references are generally numbered alike in the several views.

FIG. 1 is a partial sectional side elevational view of a conventional seed row planter.

FIG. 2 is an isometric view of an improved seed metering assembly embodying principles of the disclosed subject matter.

FIG. 3 is a block diagram of the seed population system.

FIG. 4A-4B are circuit diagrams of the seed population system.

### DETAILED DESCRIPTION OF THE PREFERRED EMBODIMENT

As required, detailed aspects of the disclosed subject matter are disclosed herein; however, it is to be understood that the disclosed aspects are merely exemplary of the invention, which may be embodied in various forms. Therefore, specific structural and functional details disclosed herein are not to be interpreted as limiting, but merely as a basis for the claims and as a representative basis for teaching one skilled in the art how to variously employ the present invention in virtually any appropriately detailed structure.

Certain terminology will be used in the following description for convenience in reference only and will not be limiting. For example, up, down, front, back, right and left refer to the invention as orientated in the view being referred to. The words, “inwardly” and “outwardly” refer to directions toward and away from, respectively, the geometric center of the aspect being described and designated parts thereof. Forwardly and rearwardly are generally in reference to the direction of travel, if appropriate. This terminology will include the words specifically mentioned, derivatives thereof and words of similar meaning.

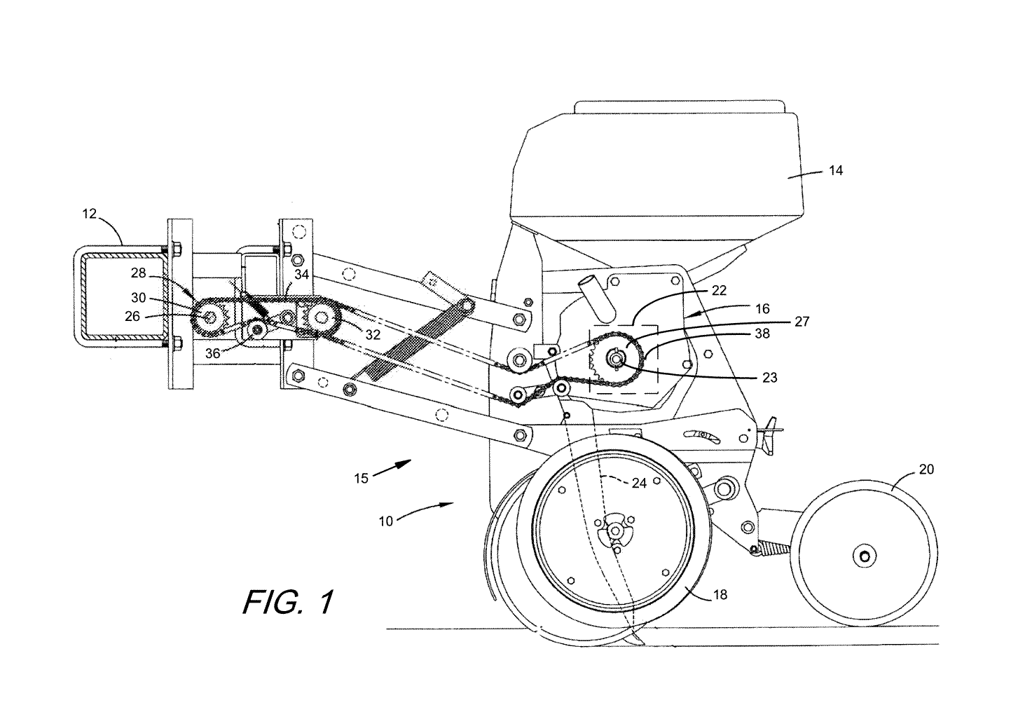

Referring to the drawings, FIG. 1 illustrates a partial sectional side elevational view of a seed planter row unit 10 of a vacuum planter having a conventional seed metering system 15. The row unit 10 is shown mounted to a tool bar 12. The tool bar 12 allows for the mounting of a plurality of seed row units. The tool bar 12 is part of a implement (not shown) that is pulled behind a vehicle (not shown). The implement has wheels that contact the ground and support the implement, and a power takeoff shaft (not shown) for powering the seed planter 10. The vehicle may include, but is not limited to a tractor.

The conventional seed metering system 15 includes a seed metering unit 16 operably connected to a transmission assembly 28. The transmission assembly 28 transfers rotational energy from a mechanical drive shaft 26 to the seed metering assembly 22 via a series of chains 34, 38, and sprockets 30, 32, and 36. The drive shaft 26 is mounted in parallel with the tool bar 12 and rotated by either the power takeoff, or ground drive from rotation of the implement wheels. The transmission assembly 28 includes a drive sprocket 30 that is mounted on the drive shaft 26. The drive sprocket 30 drives a driven sprocket 32 by the engagement of a chain 34 with an idler sprocket 36. The idler sprocket 36 maintains the tension of the chain 34. The driven chain 38 is driven by the drive sprocket 32, and drives the metering sprocket 27 at the seed metering unit 16.

A seed hopper 14 is provided for storing seeds for sowing by the individual seed planter row units 10. A seed metering unit 16 is operably connected with the seed hopper 14 for controlling transfer of the seed from the row unit 10 to the seed tube 24. To control the depth of the furrow, a pair of depth gauge wheels are positioned at both sides of the seed planter row unit 10 including an outboard depth gauge wheel 18. A furrow wheel 20 is positioned behind seed planter row unit 10 for closing the furrow and covering the seed with soil. The seed metering unit 16 is positioned below the seed hopper 14, and controls the rate of release of seeds from the seed hopper 14 into the seed tube 24 by a seed plate (not shown).

A shaft 23 extending between the interior and exterior of the seed metering unit 16 mounts the seed plate within the seed metering assembly 22, and mounts the metering sprocket 27 at the exterior of the seed metering unit 16. To change the sowing distance between seeds, a variety of sprockets with different numbers of teeth may be used for the drive sprocket 30 and the driven sprocket 32. As seen in FIG. 1, the seed metering assembly 22 is controlled by the rotation of the drive shaft 26. The drive shaft 26 is operationally connected to a rate controller on the vehicle. Therefore, the translational speed of the vehicle effectively controls the speed in which the seed metering assembly 22 releases seeds into the seed tube 24. High translational speed of the vehicle, or traversing rough or rocky terrain, may cause the drive shaft 26 to spin erratically thereby affecting the seed population. Furthermore, due to the fact that seed spacing is dependent upon the rotational speed of the seed metering disk, to achieve lighter seed populations the translational speed of the vehicle must also be very slow which is often difficult to consistently maintain while planting.

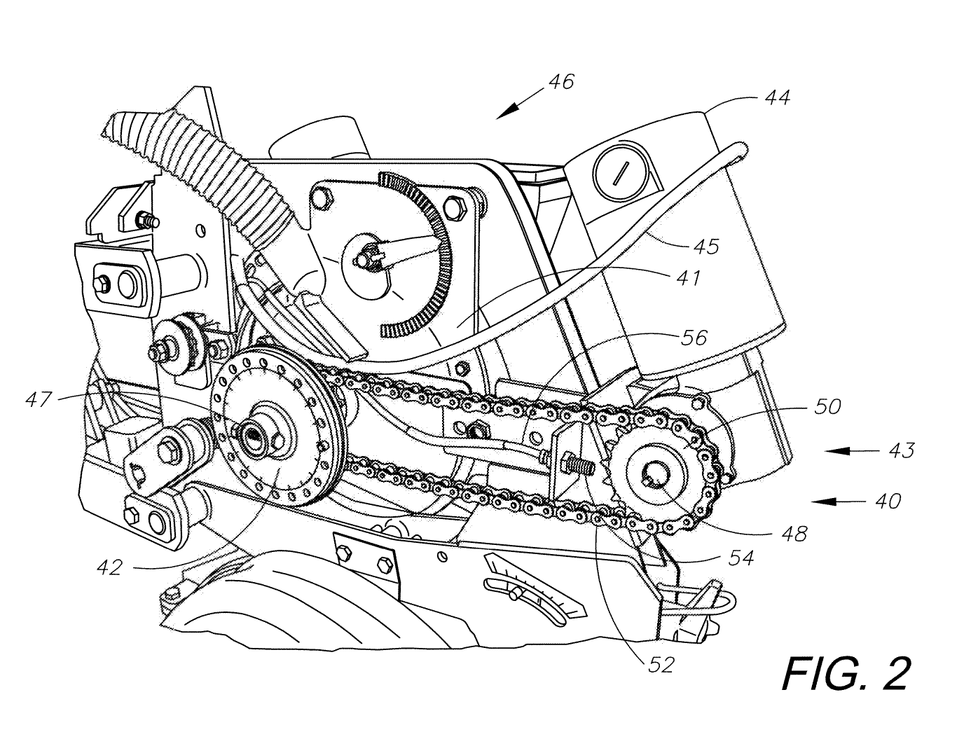

Referring to FIG. 2, an improved seed metering system 40 for a seed planter row unit 46 is shown, and includes a seed metering unit 41 operably connected to a seeding control assembly 43. The seed planter row unit 46 shown in FIG. 2 is used with a vacuum planter, however the seeding control assembly 43 may be used with non-vacuum planter units. The seeding control assembly 43 replaces the traditional transmission assembly 28 of the traditional seed planter row unit 10 shown in FIG. 1. The seeding control assembly 43 includes an electric motor 44 operably connected with the seed plate (not shown) to more efficiently and accurately control the rate of release of seeds from the seed hopper 14. In an embodiment, a shaft 47 extending between the interior of the seed metering unit 41 and the exterior of the seed metering unit 41 connects the seed plate with a metering sprocket (not shown) located on the exterior of the seed metering unit 41. The electric motor 44 drives the seed plate by rotating a drive sprocket 50 mounted to a drive shaft 48. The drive sprocket 50 engages the metering sprocket via a chain 52. In an alternative embodiment, the chain and sprockets are not used and the drive shaft 48 is directly connected to the seed plate.

The seeding control assembly 43 further comprises a seed population control unit 60 operably connected to the electric motor 44, a sensor 56, the vehicle, and the rate controller of the vehicle.

The sensor 54 monitors the rotational speed of the drive shaft 48. In an embodiment the sensor 54 is a Hall-Effect sensor. The output of the sensor 54 is sent by a wire 56 to the seeding population control unit 60. The seed population control unit 60 receives a speed signal from the vehicle corresponding to the translational speed of the vehicle, and a seed population rate signal from the rate controller on the vehicle.

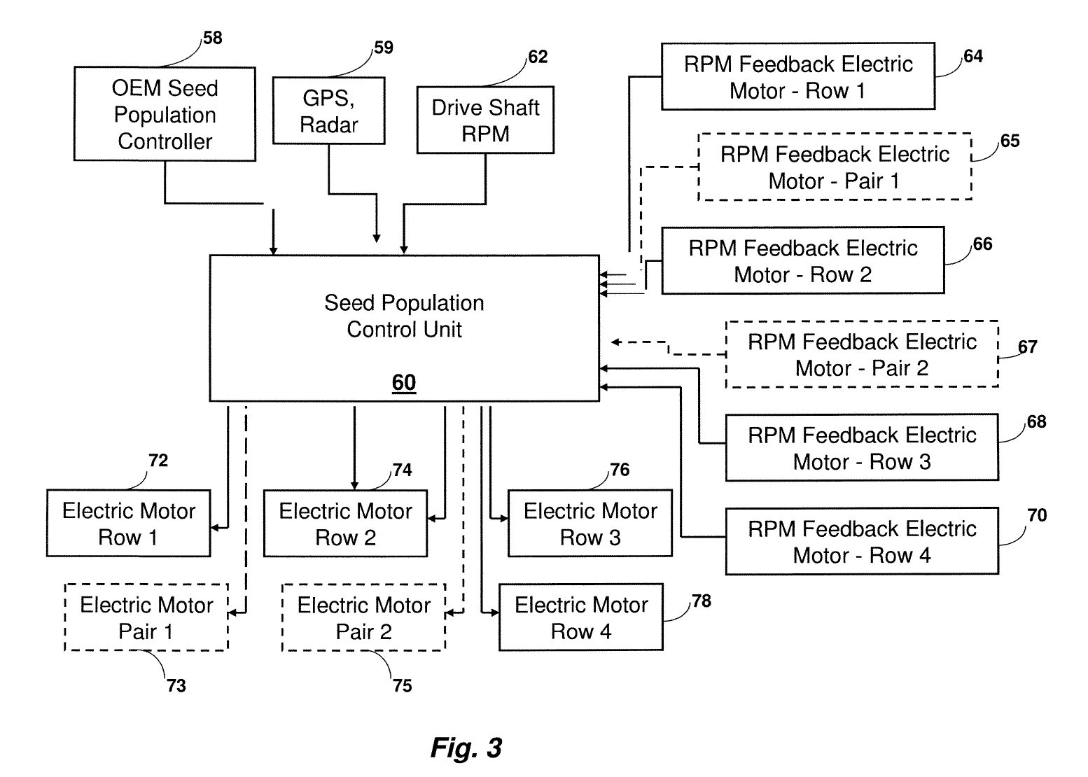

A block diagram of the seed population control unit 60 of improved seeding control assembly 43 is shown in FIG. 3. The seed population control unit 60 receives an input signal 58 in the form of the pulse width modulation from the original equipment manufacturer (OEM) seed population controller. The tractor or OEM seed population controller may also utilize global positioning system (GPS) information as well as ground speed radar the output signal or alternatively, provide an input signal 59 to the seed population control unit 60. Further, seed population control unit 60 receives an input signal 62, also in the form of pulse width modulation, from the sensor 54 that is measuring the revolutions per minute (RPM) of the drive shaft 48 driven by the electric motor 44. The seed population control unit 60 compares the signals from the sensor 54 with the output from the OEM seed population controller 62 to determine the effective seed population. To ensure the correct planted seed population, the seed population control unit 60 is operably connected to the electric motor 44 by a wire 45 and provides two-way communication. Seed population control unit 60 receives an RPM feedback signals 64, 66, 68, 70 from the electric motor 44 adapted to the individual seed planter row units 10. An embodiment of seed population control unit 60 controls a pair of twin row planting units. An electric motor is associated with each seed metering system of the twin row planting units and provides RPM feedback signals 64, 65, 66 and 67 as illustrated in FIG. 3.

Outputs of the seed population control unit 60 are used to power and control the electric motors associated with each individual seed metering system. The resulting output signals from the seed population control unit 60 more accurately controls the planted seed population by compensating for varying translational speed signals received from the vehicle, and eliminates multiple components which may become worn and result in uneven seed spacing. Likewise, seed population control unit 60. Each seed planter row unit 54 receives an input signal from seed population control unit 60 as shown in FIG. 3 to control the electric motor 44 associated with the first row unit 72, second row 74, third row unit 76, and forth row unit 78. An embodiment that utilizes a twin row planter, utilizes an electric motors on each of the seed metering system and also replaces the mechanical linkage that controls the alternating action of the seed placement that prevents the placement of two seeds next to each other in the pair of rows. Returning to FIG. 3, seed population control unit 60 provides output signals 72 and 73 to the electric motors on one twin row planter assembly and output signals 74 and 75 to the electric motors on another pair of twin row planter assembly. Seed population control unit 60 compares the feedback signals from each motor in the pair, 64 and 65 to alternate the placement of seeds in the rows of the twin row planter assembly.

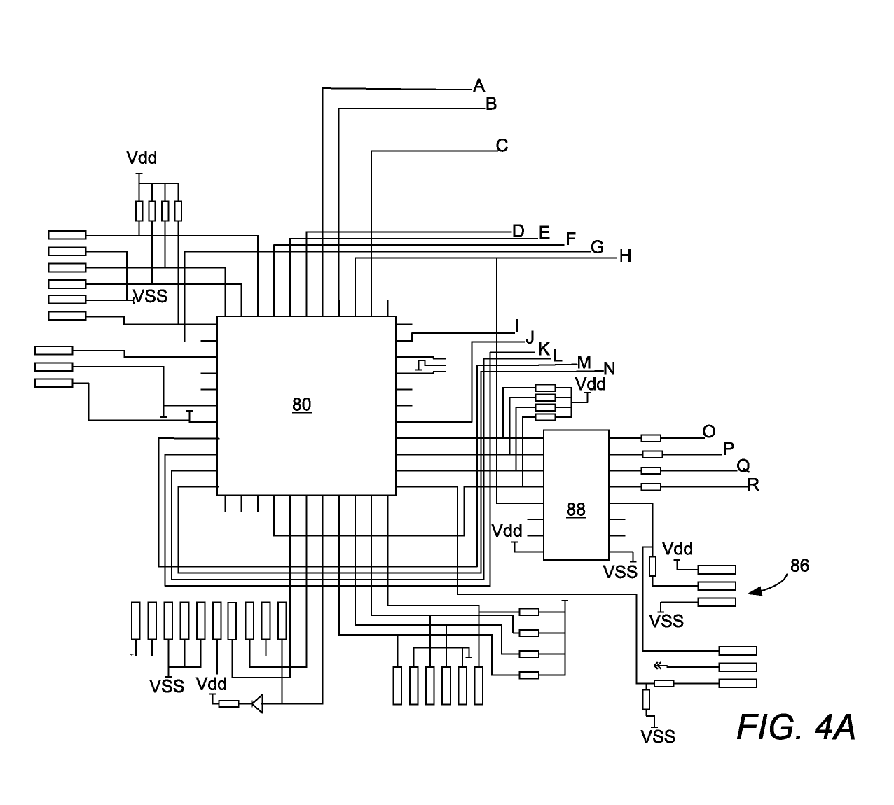

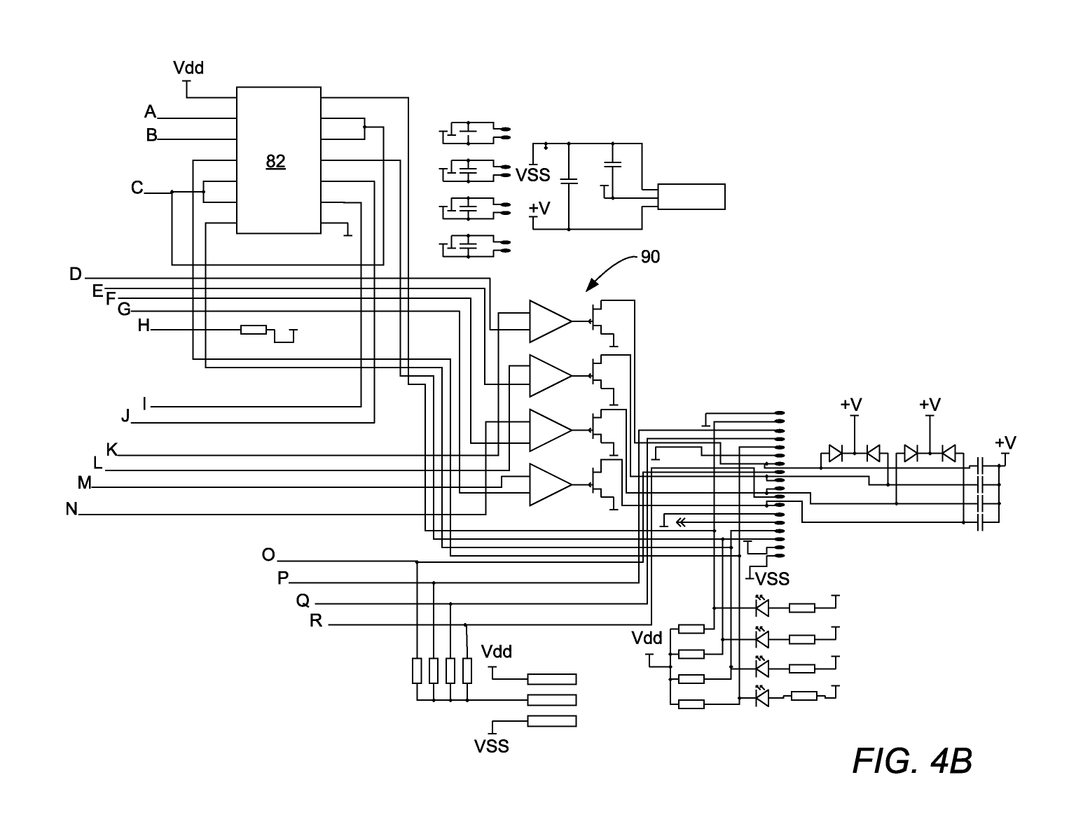

A schematic of the electrical circuitry of the seed population control unit 60 is shown in FIG. 4A and 4B and the schematic is described in the terms of the major components that are used to integrate the electronics of OEM and aftermarket seed metering units, GPS and similar controllers. These components are combined with the electric motors as described above to drive conventionally driven mechanical seed metering units. One embodiment of the seed population control unit 60 contains the electronics to control two, twin row planting units. The seed population control unit 60 utilizes a microprocessor 80 to receive the input signals from the rate controller, vehicle, and sensor 54 on each seed planter row unit 46 for controlling the seeding population of each row unit 46.

An embodiment utilized the 44 pin, enhanced flash, high-performance pulse width modulation and high speed analog to digital converter microcontroller such as PIC18F4431 by Microchip Technology, Inc. Microprocessor 80 receive inputs from each electric motor that drives the seed metering unit of the seed planter row unit. A Hall-Effect sensor is utilized to measure the revolutions per minute of each electric motor that controls the seed metering unit. Each speed RPM signal is received by a quad bilateral switch IC 82 such as 74HC4066 quad bilateral switch IC manufactured by Texas Instruments, Fairchild or others IC manufacturers. Quad bilateral switch IC 82 is utilized by microprocessor 80 to measure the speed of each electric motor using one input channel of microprocessor 80 that utilizes an oscillator 84 to internally control the switching (on/off) and reading of the output from quad bilateral switch IC 82 such as a PBRC20.00HR.

Microprocessor 80 also receives an input from the GPS or other locating device signal of the tractor such as a GPS from the OEM tractor manufacturer or as an after-market added device such as those manufactured by Garmin or cellular GPS locators commonly available by cellular service providers. A jumper 86 is used to accommodate either a high or low signal from GPS or other locating device and a high-voltage, high-current Darlington transistor array 88 is also used as a relay driver. Microprocessor 80, as programmed, utilizes the pulse width modulation signal from the GPS to control the electric motors for delivering the desired seed population. A series of gate and MOSFET 90 is used in combination as the low side drivers to microprocessor 80 for each electric motor.

It will be appreciated that the components of the seed metering system 40 can be used for various other applications. Moreover, the seed metering system 40 can be fabricated in various sizes and from a wide range of suitable materials, using various manufacturing and fabrication techniques.

It is to be understood that while certain aspects of the disclosed subject matter have been shown and described, the disclosed subject matter is not limited thereto and encompasses various other embodiments and aspects.

Having thus described the disclosed subject matter, what is claimed as new and desired to be secured by Letters Patent is:

1. A method for controlling the density of seeds delivered by a row crop seed planter having a seed planter row unit, a power source, a microprocessor and a drive unit associated with the seed planter row unit, the method comprising:
(a) receiving an user selected seed population value;
(b) calculating an output signal to achieve the selected seed population value;
(c) sending the calculated output signal to the drive unit;
(d) receiving a location signal;
(e) receiving a translational speed value;
(f) receiving a feedback signal from the drive unit;
(g) calculating an actual seed population density;
(h) comparing the actual seed population density with the user selected seed population value;
(i) determining a compensation factor; and
(j) adjusting an output signal to the drive unit.

2. The method of claim 1 wherein the step of receiving a user selected seed population value includes an user, inputting a seed population value inputted into a user interface operatively connected to the row crop seed planter.

3. The step of claim 2 wherein inputting a user selected seed population value inputted into a user interface operatively connected to the row crop seed planter further includes entering a location for the user selected seed population.

4. The method of claim 1 wherein the step of calculating an output signal to achieve the selected seed population value includes calculating a mathematical formula representing a range of translational speeds of and corresponding rotational speeds to achieve the user selected seed population value at the location.

5. The method of claim 4 wherein the step of calculating a mathematical formula representing a range of translational speeds of and corresponding rotational speeds to achieve the user selected seed population value includes converting the output of the mathematical formula into a voltage.

6. The method of claim 5 wherein converting the output of the mathematical formula into an voltage further includes storing the mathematical formula and voltages in a memory location.

5. The method of claim 1 wherein the step of calculating an actual seed population density includes converting the feedback signal into an angular velocity and determining the number of seeds planted over a unit of area.

6. The method of claim 1 wherein the step of determining a compensation factor includes calculating a voltage.

7. An apparatus for controlling the seed population delivered by a row crop seed planter having a seed planter row unit and a seed metering system, the apparatus comprising:
(a) a power source;
(b) a microprocessor;
(c) a drive unit;
(d) a translational speed sensor; and
(e) a location sensor.
